(19) United States
(12) Patent Application Publication
(10) Pub. No.: US 2014/0129359 A1
(43) Pub. Date: May 8, 2014

(54) EDUCATIONAL MONETARY TRANSACTION MACHINE AND SYSTEM

(71) Applicant: Tracy Mayobre, Leesburg, VA (US)

(72) Inventor: Tracy Mayobre, Leesburg, VA (US)

(21) Appl. No.: 14/057,937

(22) Filed: Oct. 18, 2013

Related U.S. Application Data
(60) Provisional application No. 61/723,244, filed on Nov. 6, 2012.

(51) Int. Cl. G06Q 20/20; G06Q 50/20

(52) U.S. Cl. CPC G06Q 20/204; G06Q 50/20
USPC 705/17; 705/16

(57) ABSTRACT

An educational monetary transaction machine including a processor with a memory to store data including at least one simulated account with a simulated amount of money. The present invention may further include an identification input. The computer may receive the identification input to access the simulated account. The present invention may further include a display that displays the simulated account and the simulated amount of money. A user interface may be connected to the computer so that a user may simulate the withdrawal and deposit of simulated money within the simulated account.

### CROSS-REFERENCE TO RELATED APPLICATION

This application claims the benefit of priority of U.S. provisional application No. 61/723,244, filed Nov. 6, 2012, the contents of which are herein incorporated by reference.

### BACKGROUND OF THE INVENTION

The present invention relates to monetary transaction machine and, more particularly, to an educational monetary transaction machine and system.

Currently, educational institutions fail to provide an electronic device to help students learn and understand the monetary system. The educational system may try to teach students by using text books, fake paper money, fake checks and the like. However, a majority of monetary transactions are performed electronically. Therefore, the methods mentioned above are outdated and fail to provide a solid basis of how transactions are made.

As can be seen, there is a need for an educational machine that provides a system for students to learn how to perform electronic transactions.

### SUMMARY OF THE INVENTION

In one aspect of the present invention, an educational monetary transaction machine comprises: a processor connected to a memory, wherein the memory stores data, wherein the data comprises at least one simulated account comprising a simulated amount of money; an identification input, wherein the processor receives the identification input to access the at least one simulated account; a display to display the at least one simulated account; and a user interface operatively connected to the processor, wherein the user interface comprises at least one of a withdraw selection and a deposit selection to control the amount of simulated money within the at least one simulated account.

In another aspect of the present invention, a system for the education of the monetary system, comprises: a computer having a memory and user interface; and a program product comprising machine-readable program code for causing, when executed, the computer to perform the following process steps: prompting a user to access at least one simulated account comprising a simulated amount of money; receiving an identification input to access the at least one simulated account; displaying the at least one simulated account to the user; prompting a user to select at least one of a withdraw command and a deposit command; receiving at least one of the withdraw command and the deposit command; and calculating a new amount of simulated money based on the withdraw and deposit command.

These and other features, aspects and advantages of the present invention will become better understood with reference to the following drawings, description and claims.

### BRIEF DESCRIPTION OF THE DRAWINGS

FIG. 1 is multiple perspective views of an educational monetary transaction machine;

FIG. 2 is a perspective view of the embodiment of FIG. 1 including a side view, a front view and an example of a belt clip fully engaged; and

FIG. 3 is a perspective view of the embodiment of FIG. 1 with an engaged identifying device.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention may include at least one computer with a memory and a user interface. The computer may include any computer including, but not limited to, a desktop, laptop, and smart device, such as, a tablet and smart phone. However, in certain embodiments, the computer of the present invention may be made as a standalone device. The computer may include a program product including a machine-readable program code for causing, when executed, the computer to perform steps. The program product may include software which may either be loaded onto the memory of the computer or accessed by the computer. The loaded software may include an application on a smart device. The software may be accessed by the computer using a web browser. The computer may access the software via the web browser using the internet, extranet, intranet, host server, internet cloud and the like.

Broadly, an embodiment of the present invention provides an educational monetary transaction machine including a computer with a memory to store data including at least one simulated account with a simulated amount of money. The present invention may further include an identification input. The computer may receive the identification input to access the simulated account. The present invention may further include a display that displays the simulated account and the simulated amount of money. A user interface may be connected to the computer so that a user may simulate withdraw and deposit of simulated money within the simulated account.

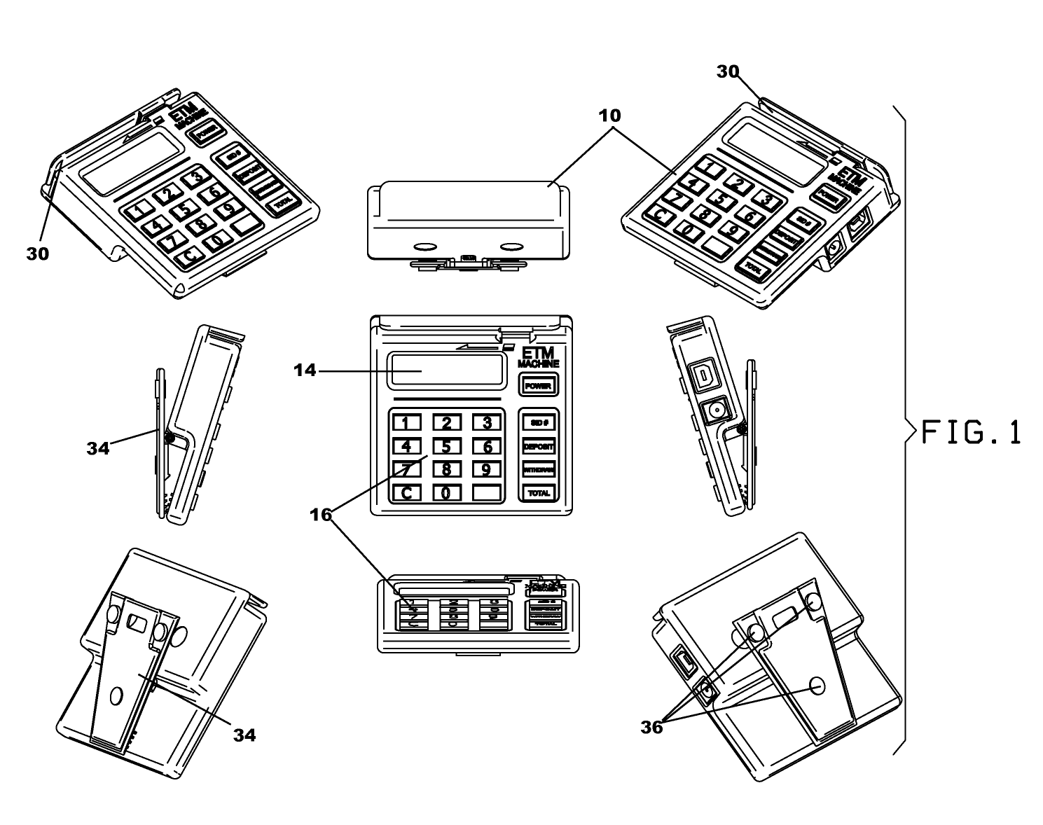

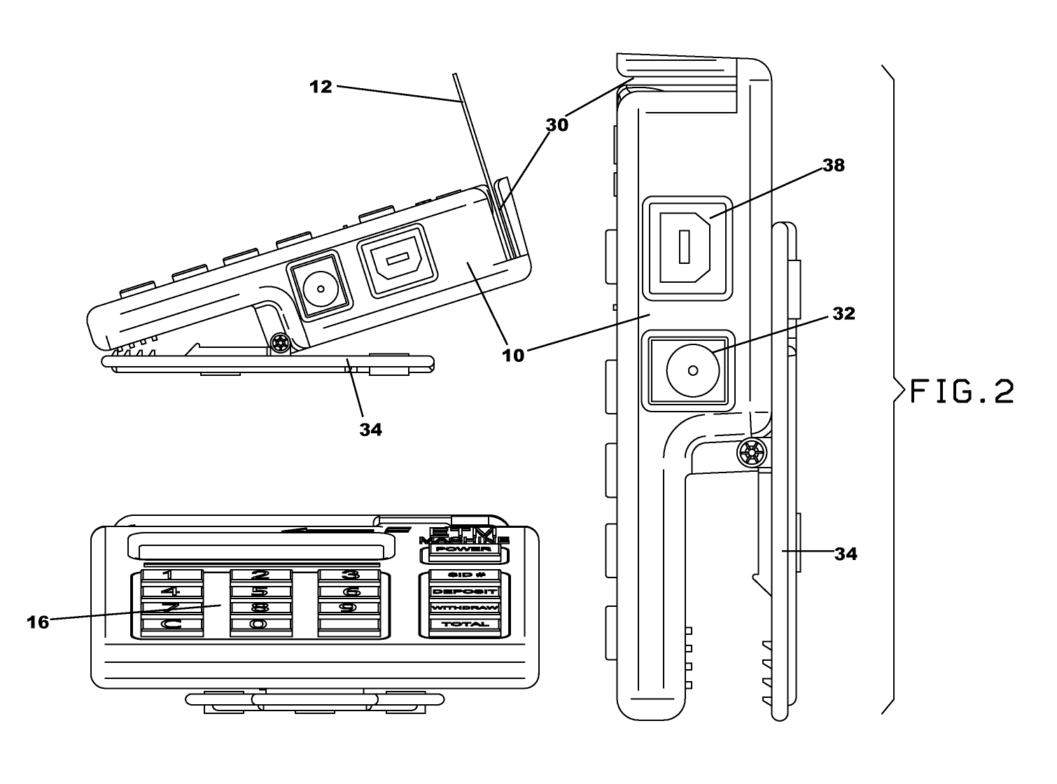

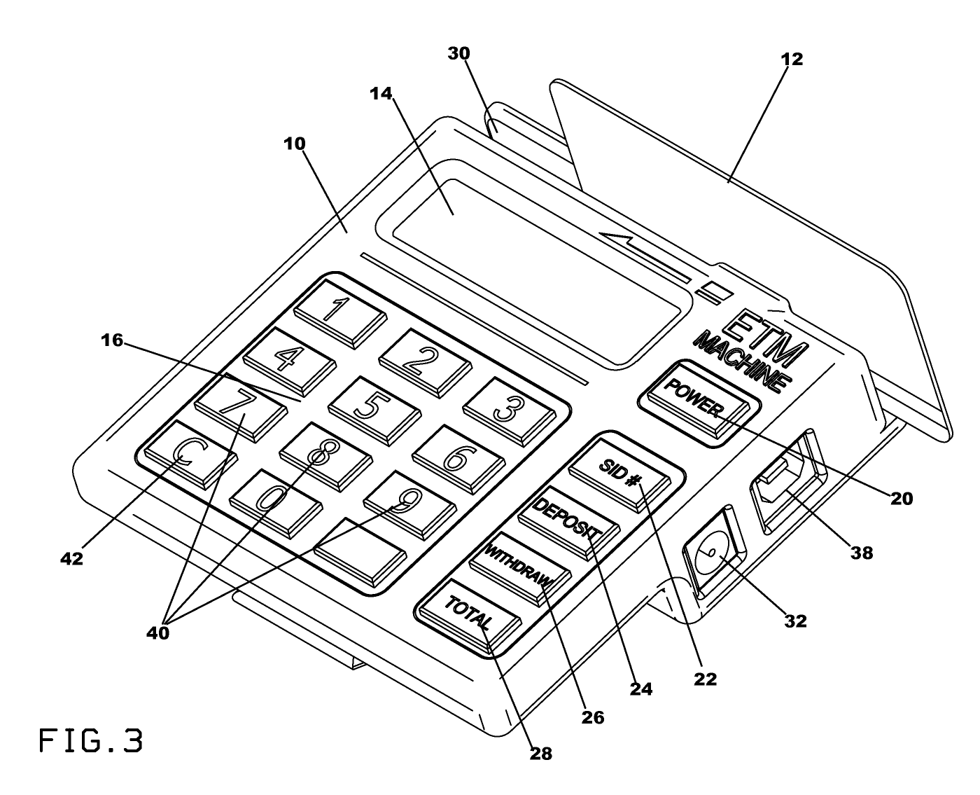

Referring to FIGS. 1 through 3, the present invention may include an educational monetary transaction machine. The educational monetary transaction machine may be a processor, such as a computer. The computer may include a housing 10 such as a plastic case to cover and enclose the hardware. The housing 10 and the size of the machine may be, but is not limited to, about 3 inches in width, about 5 inches in height, and about 1 inch in depth. The hardware of the computer may include an internal memory device, such as a hard drive, or an external memory either directly connected to the computer or accessed wirelessly. The memory may store data having at least one simulated account with a simulated amount of money within. The computer may further include a user interface to control the amount of money within the account. The present invention may further include a display 14 operatively connected to the computer. The display 14 may include, but is not limited to, liquid crystal display (LCD), Light Emitting Diode (LED), organic OLED, plasma, or any other suitable device used as a television or display.

The present invention may further include an identification input. The computer may receive the identification input to access the at least one simulated account and display the at least one simulated account on the display 14. For example, the identification input may include an inputted code, such as username and password, or an identifying number that may be entered into the user interface. As illustrated in the Figures the identifying number may be entered by pressing the SID button (student identification). In certain embodiments, the identification input may include a tangible object such as a card 12 with a magnetic strip, an electronic key, a scannable device, a portable memory device, and the like. As illustrated in the Figures, the identifying device may be a card 12 with a magnetic strip. In such embodiments, the educational monetary transaction machine may include a swiping strip 30. The user may swipe the card 12 in the swiping strip 30, and the computer may identify the user and provide a simulation of a user's monetary amount on the display 14. The swiping strip 30 may be located on the top, bottom, back, front or sides of the housing 10. As illustrated in the Figures, the swiping strip 30 may be on the top of the housing 10.

The computer may be controlled by the user interface. The user interface may be used to control how much a user may withdraw and deposit the simulated amount of money within the simulated account. The user interface may include of a keypad 16 with buttons, a keypad 16 on a touch screen digital display, sound activation and the like. As illustrated in FIGS. 1 through 3, the user interface may be a keypad 16 with buttons. In certain embodiments, when the user interface includes a keypad 16 or a keyboard with buttons, the buttons or digital display may include numbered digits 40, a withdraw button 26, a deposit button 24, a total button 28, a clear button 42, a SID button 22, a power button 20, or a combination thereof. In certain embodiments, when the above buttons are selected, the display 14 may provide an indication of which button has been pressed and in certain embodiments, an indication of a amount of battery power.

In certain embodiments, the educational monetary transaction machine may include an alternating current adapter input 32 and/or a battery compartment for a battery. In certain embodiments, the battery may be rechargeable or disposable. The battery compartment allows for the educational monetary transaction machine to be a portable device. The AC input 32 may be used for charging the battery. However, in certain embodiments, the educational monetary transaction machine may include a power cable to plug into an outlet.

The education monetary transaction machine may further include accessories. The accessories may include, but are not limited to, a plastic belt clip 34, a pullout stand and the like. The plastic belt clip 34 may clip to a belt and attach the education monetary transaction machine to a user. The pull out stand may be on the back of the housing 10 and pull out to allow the housing 10 to rest on a surface at an angle and is therefore easy to use. In certain embodiments, the clip 34 may serve as a desk stand. The pull out stand or clip 34 may include a grip 36. For example, the clip may include three small round grips 36 on the bottom surface to prevent the machine from moving around on the desk. The machine may further have a Universal Serial Bus (USB) port 38 for uploading and downloading information onto and from the machine. For example, the machine may upload information including a spreadsheet of the transactional history of the machine as a whole or for individual users. The USB port 38 may also be used for charging the machine.

As mentioned above, the computer may include an internal memory. In certain embodiments, the internal memory may be used to store user information, account balances, and the like. The internal memory may include a hard drive. Since the machine may include an internal memory, it is not necessary for the machine to be connected to an outside server via the internet. However, it is envisioned that the machine may include a USB port 38 or an internet adapter to have access to information stored on servers, remote computers, internet cloud systems and the like, for the purposes of uploading and storing information on the machine.

In use, the education monetary transaction machine may be used as a tool to teach accounting skills and a behavior reward system in an educational setting, such as in schools. The machine may be used by a single user in a classroom, for example. An entire school setting may also use multiple machines. The simulated account and simulated amount of money do not represent actual money corresponding to wealth and are used for teaching purposes.

In certain embodiments, the user may use the education monetary transaction machine by first swiping a card 12 with a magnetic strip in a swiping strip 30 on the machine. The swiping strip 30 may be capable of reading the specially designed magnetic card 12 and thereby accessing user information and an account balance. Once the user has accessed their account balance, the user may add (deposit) or subtract (withdraw) amounts of a simulation of money from their individual account. The user may perform such actions by using the user interface, such as a keypad 16. The keypad 16 includes numbered buttons and a deposit and withdraw button for such actions. A user may further use a USB cable or a portable memory device to upload information onto a remote computer. The information may include spreadsheets of the user's transactions.

The present invention may further include a system for the education of the monetary system. The system may include a computer having a memory and user interface and a program product comprising machine-readable program code for causing, when executed, the computer to perform process steps. The steps may include: prompting a user to access at least one simulated account comprising a simulated amount of money; receiving an identification input to access the at least one simulated account; displaying the at least one simulated account to the user; prompting a user to select at least one of a withdraw command and a deposit command; receiving at least one of the withdraw command and the deposit command; and calculating a new amount of simulated money based on the withdraw and deposit command. In certain embodiments, the reception of at least one of the withdraw command and the deposit command may include a simulated transaction. The simulated transaction may be stored on the memory of the computer. The stored simulated transactions may be displayable on a display operatively connected to the computer. The computer may be connected with a printer to print the simulated transactions as a spread sheet.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. An educational monetary transaction machine comprising:
a processor connected to a memory, wherein the memory stores data, wherein the data comprises at least one simulated account comprising a simulated amount of money;
an identification input, wherein the computer receives the identification input to access the at least one simulated account;
a display to display the at least one simulated account; and
a user interface operatively connected to the processor, wherein the user interface comprises at least one of a withdraw selection and a deposit selection to control the amount of simulated money within the at least one simulated account.

2. The educational monetary transaction machine of claim 1, further comprising a housing, wherein the processor is within the housing.

3. The educational monetary transaction machine of claim 2, wherein the identification input comprises at least one of an inputted code and a scannable device.

4. The educational monetary transaction machine of claim 3, wherein the scannable device comprises a swiping strip operatively attached to the processor and a swiping card comprising a magnetic strip, wherein the swiping strip reads the magnetic strip.

5. The educational monetary transaction machine of claim 2, further comprising a touch screen, wherein the touch screen is at least one of the user interface and the display.

6. The educational monetary transaction machine of claim 2, wherein the user interface comprises a keypad comprising buttons.

7. The educational monetary transaction machine of claim 6, wherein the buttons comprise at least one of a plurality of numbered buttons, a deposit button, a withdrawal button, a total button, and an SID button.

8. The educational monetary transaction machine of claim 2, further comprising a battery within the housing.

9. The educational monetary transaction machine of claim 8, wherein the battery is rechargeable.

10. The educational monetary transaction machine of claim 2, further comprising a universal serial bus port mounted to the housing and operatively connected to the memory.

11. The educational monetary transaction machine of claim 2, further comprising a clip mounted to the housing.

12. A system for the education of the monetary system, comprising:
a computer having a memory and user interface; and
a program product comprising machine-readable program code for causing, when executed, the computer to perform the following process steps:
prompting a user to access at least one simulated account comprising a simulated amount of money;
receiving an identification input to access the at least one simulated account;
displaying the at least one simulated account to the user;
prompting a user to select at least one of a withdraw command and a deposit command;
receiving at least one of the withdraw command and the deposit command; and
calculating a new amount of simulated money based on the withdraw and deposit command.

13. The system of claim 12, wherein the reception of at least one of the withdraw command and the deposit command comprises a simulated transaction.

14. The system of claim 13, wherein each simulated transaction is stored on the memory of the computer.

15. The system of claim 14, wherein the stored simulated transactions are displayable on a display operatively connected to the computer and are printable.
